(19) United States
(12) Patent Application Publication
(10) Pub. No.: US 2012/0293717 A1
(43) Pub. Date: Nov. 22, 2012

(54) DISPLAY DEVICE AND TELEVISION RECEIVER

(75) Inventor: Yoshiki Takata, Osaka-shi (JP)

(73) Assignee: SHARP KABUSHIKI KAISHA, Osaka-shi, Osaka (JP)

(21) Appl. No.: 13/521,306

(22) PCT Filed: Dec. 10, 2010
(86) PCT No.: PCT/JP2010/072198

§ 371 Date: Jul. 10, 2012

(30) Foreign Application Priority Data
Jan. 12, 2010 (JP) 2010-004072

(51) Int. Cl. H04N 5/44; G09G 5/10

(52) U.S. Cl. 348/725; 345/690; 348/E05.096

(57) ABSTRACT

Scan lighting by an edge-light-type backlight device is applicable in a large-screen display device. A display panel 11 in a display device 10 includes data lines SL arranged in a long-side direction of the panel and configured to supply display data to display pixels and scan lines GL arranged in a short-side direction of the panel and configured to be scanned in the long-side direction thereof. A backlight device 12 in the display device 10 includes light sources 24 arranged in the long-side direction of the panel near an edge of one of the long sides of the panel and configured to be turned on through scan lighting in the long-side direction of the panel according to scanning of the scan lines SL, and a light guide member 26 provided behind the panel and configured to direct light from the light sources 24 in the short-side direction of the panel.

### TECHNICAL FIELD

The present invention relates to a display device and a television receiver including the display device. More particularly, the present invention relates to lighting control of a backlight of the display device.

### BACKGROUND ART

Conventionally, an active-matrix-type liquid crystal display device, which is one kind of display devices, is a hold-type display device. In the hold-type display device, display data is held for a predetermined period in display pixels including active elements such as FTF (thin film transistor). This is different from an impulse type display device such as a cathode-ray tube display device. When fast moving images are displayed on the active-matrix-type liquid crystal display device, the moving images may be blurred, that is, so-called “motion blurs (afterimage)” may be produced. Accordingly, various technologies have developed for reducing “motion blurs.” In the technology disclosed in Patent Document 1, a backlight of a liquid crystal display device is not continuously turned on but intermittently turned on according to gate line scanning (hereinafter “scan lighting”). Furthermore, operations of the backlight and the display panel are controlled in synchronization with a high frame rate to prevent the large-screen liquid crystal display device from flickering at the periphery thereof in the technology disclosed in Patent Document 1.

Patent Document 1: Japanese Unexamined Patent Publication No. 2006-91242

### Problem to be Solved by the Invention

The technology disclosed in Patent Document 1 mainly uses cold cathode tubes as the backlight and the display panel is illuminated with direct light on the back thereof as shown in FIG. 1 of the Patent Document 1. A so-called edge-light backlight device is configured to illuminate a display panel with light from an edge of the display panel and guided by a light guide plate. When the edge-light backlight device is used for scan lighting, a preferable performance of the scan lighting in a large-screen liquid crystal display device cannot be achieved. If a size of the display panel increases, a light guide distance of the light guide plate increases . As a result, a light loss occurs. In addition, the light sources are arranged only on the short sides of the display panel, each of which has only 9/16 length of a long side of the display panel. Accordingly, the display panel size is limited if scan lighting using the edge-light type backlight device is applied to a liquid crystal display device.

### DISCLOSURE OF THE PRESENT INVENTION

The present invention was accomplished in view of the above circumstances. It is an object of the present invention to provide a display device and a television receiver including an edge-light-type backlight device that is applicable in the large-screen display device and the large-screen television receiver.

### Means for Solving the Problem

To solve the above problem, a display device according to the present invention includes a display panel formed in a rectangular shape having two long sides and two short sides and including a plurality of display pixels arranged in rows and columns, and a backlight device configured to illuminate the display panel. The display panel includes: a plurality of data lines arranged in a long side direction of the display panel and configured to supply display data to the display pixels; and a plurality of scan lines arranged in a short side direction of the display panel and configured to be driven and scanned in the long side direction of the display panel. The backlight device includes: a plurality of light sources provided in a vicinity of an edge of one of the long sides of the display panel and arranged in a long side direction thereof, the light sources configured to be turned on through the scan lighting in the long side direction of the display panel according to scanning of the scan lines and; a light guide member provided behind the display panel and configured to direct light from the light sources in a short side direction of the display panel.

In such a configuration, a plurality of light sources are arranged in the long-side direction of the liquid crystal panel and are configured to be turned on through the scan lighting in the long-side direction of the liquid crystal panel. Conventionally, the scanning direction of a liquid crystal panel is the short-side direction thereof. A plurality of light sources are arranged in the short-side direction of the liquid crystal panel, and a plurality of light sources are configured to be turned on through scan lighting in the short-side direction of the liquid crystal panel. Compared to such a configuration, the length of the long-side of the light guide member is shorter, and the number of light sources that are turned on through scan lighting is increased. Therefore, the edge-light-type backlight device configured to perform the scan lighting can be applied in a large-screen display device. With the backlight sources driven through the scan lighting, the large-screen display device can display images in improved quality by the scan lighting. Here, “scan lighting” of a plurality of light sources means that the light sources are turned on intermittently and the light sources that are not turned on are turned off. The light sources may be turned on and off individually and the light sources may be turned on and off in a unit of two or more light sources.

The light sources may be turned on through the scan lighting per light source unit including a predetermined number of light sources. With such a configuration, lighting on and off may be controlled per predetermined number of light sources. If the number of light sources is large, the light sources are easily turned on through the scan lighting.

The backlight device may include a plurality of light source units each including at least one of the light sources and the light guide member. The light sources may be configured to be turned on through scan lighting on light source unit basis. Parts of the backlight device having such a configuration are provided in units and thus the parts can be easily replaced. Furthermore, the light sources are turned on through scan lighting per unit, and the scan lighting of the light sources are easily performed.

The backlight device may include a plurality of light source units including a predetermined number of light sources and the light guide member. The predetermined number of the light sources may be provided in a plurality of groups. The light sources may be configured to be turned on through scan lighting on group basis. The parts of the backlight device having such a configuration are provided in units and the parts in each unit can be easily replaced. Furthermore, scan lighting of the light sources is performed per group in the unit. Accordingly, the scan lighting is performed in a smaller unit compared to a configuration where scan lighting is performed per unit.

The display device may further include a plurality of scanning line drivers provided close to one of the long sides of the display panel and configured to drive and scan the scan lines. The light sources may be turned on through the scan lighting on scanning line driver basis. With such a configuration, the light sources are turned on through the scan lighting based on scan signals of the scanning line drivers. Accordingly, scan lighting is controlled easily.

The data lines may be provided in two groups in a middle portion of the display panel. The scan lines may be provided in the groups and configured to be scanned separately. With such a configuration, the scan lighting of the light sources is applicable in a larger-screen display device.

The scan lines may be configured to be scanned from short side edges of the display panel to the middle portion thereof. Such a configuration is preferable to reduce the deterioration of display quality near the division borders due to the division of display.

The scan lines may be provided in groups in the short side direction of the display panel. The scanning line drivers may be provided close to the long sides of the display panel. With such a configuration, the scan lighting of the light sources is applicable in a larger-screen display device.

The display device may further include a frame memory configured to store image data per frame included in a video signal and a video signal processing circuit configured to store the image data per frame into the frame memory and read out the stored image data per frame for image data of an image at a position corresponding to the each scan line. With such a configuration, image data to be scanned in the short-side direction of the display panel is adequately converted to image data to be scanned in the long-side direction of the display panel.

The display device may further include a double speed drive circuit configured to change a frame rate of images to be displayed on the display panel. With such a configuration, the frame rate is increased to 120 Hz, for example. Technology for reducing “motion blurs” is made possible with the increase of the frame rate in addition to the scan lighting efficiency of the backlight light sources.

The display device may further include a backlight control circuit configured to change an amount of current supplied to the light sources in turning-on periods within a frame display period in accordance with turning-off periods within the frame display period. The amounts of currents may be preferably increased in proportion to turning-off periods. With such a configuration, the amounts of currents supplied to the light sources vary in accordance with the turning-on periods (lighting duty) within a frame display period. Namely, brightness of the light sources in the turning-on periods is increased in proportion to the turning-off periods. Therefore, even if the display panel is large and the lighting period becomes short (lighting duty is reduced), a desired amount of light sources is obtained.

The light sources may be LEDs. With such a configuration, scan lighting of the light sources are finely performed.

The display panel may be a liquid crystal panel using liquid crystals filled between base boards. The display panel may be a liquid crystal panel. The display device as a liquid crystal display device has a variety of applications, such as a television display or a personal-computer display. Particularly, it is suitable for a large screen display.

### Advantageous Effect of the Invention

The scan lighting by an edge-light-type backlight device according to the present invention is applicable in a large display device and a television receiver.

### BRIEF DESCRIPTION OF THE DRAWINGS

FIG. 1 is an exploded perspective view illustrating a general configuration of a television receiver according to a first embodiment of the present invention;

FIG. 2 is an exploded perspective view illustrating a general configuration of a liquid crystal display device included in the television receiver;

FIG. 3 is a plan view illustrating a general wiring diagram of a liquid crystal panel of the liquid crystal display device;

FIG. 4 is a block diagram illustrating a configuration of a circuit board of the liquid crystal display device;

FIG. 5 illustrates correspondence relationships between a backlight device and gate driver scanning;

FIG. 6 illustrates correspondence relationships between the backlight device and the gate driver scanning according to a second embodiment;

FIG. 7 illustrates other correspondence relationships between the backlight device and the gate driver scanning; and

FIG. 8 illustrates other correspondence relationships between the backlight device and the gate driver scanning.

### BEST MODE FOR CARRYING OUT THE INVENTION

### First Embodiment

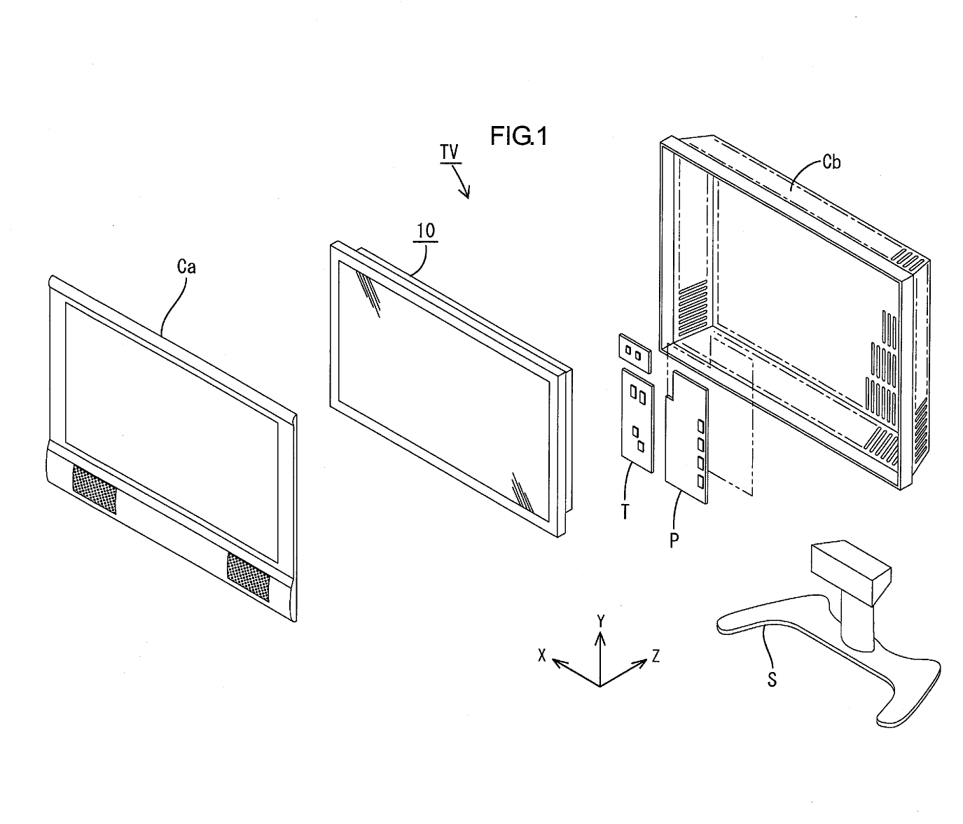

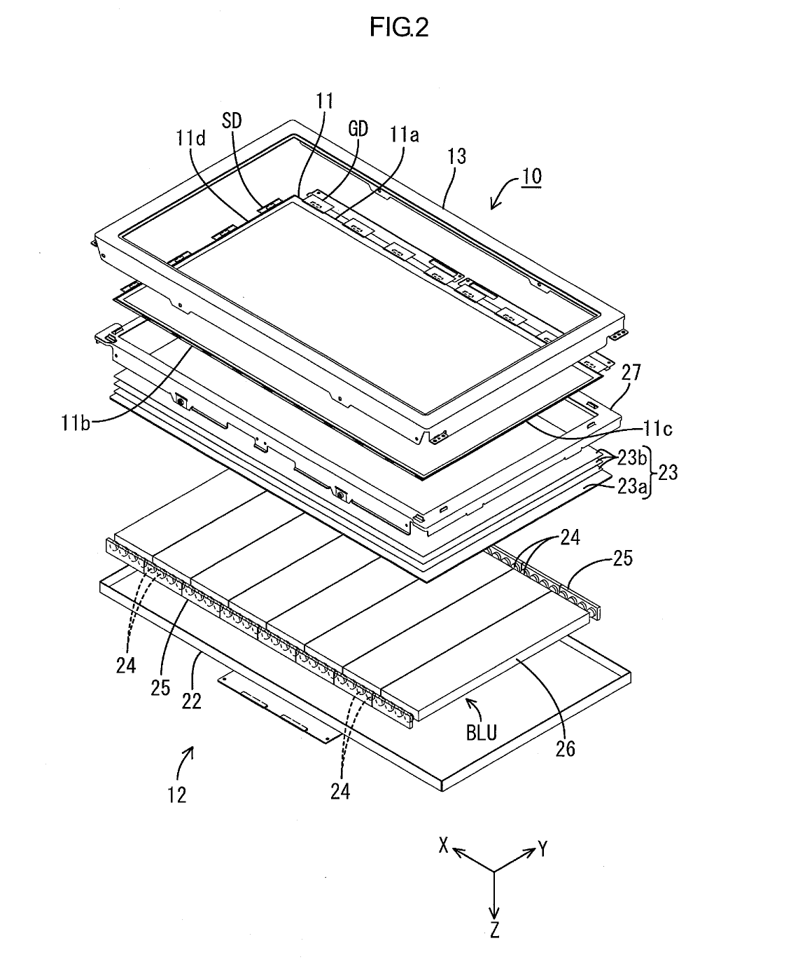

A first embodiment of the present invention will be described with reference to FIGS. 1 to 5. An X axis, a Y-axis and a Z-axis are described in a part of the drawings, and a direction of each axial direction corresponds to a direction described in each drawing. An upper side in FIG. 2 corresponds to a front-surface side and a lower side in FIG. 2 corresponds to a rear-surface side.

1. Construction of Television Receiver

As illustrated in FIG. 1, the television receiver TV of the first embodiment includes the liquid crystal display device (display device) 10, front and rear cabinets Ca, Cb which house the liquid crystal display device 10 therebetween, a power source P, a tuner T and a stand S. An entire shape of the liquid crystal display device 10 is a landscape rectangular. The liquid crystal display device 10 is housed in a vertical position. As illustrated in FIG. 2, the liquid crystal display device 10 includes a liquid crystal panel (display panel) 11, and a backlight device 12 as an external light source. The liquid crystal panel 11 and the backlight device 12 are integrally held by a frame shaped bezel 13 and the like.

As illustrated in FIG. 2, the liquid crystal panel 11 is formed in a rectangular shape in a plan view and has two long sides (11a and 11b) and two short sides (11c and 11d). In the liquid crystal panel 11, a pair of glass substrates is bonded together with a predetermined gap therebetween and liquid crystal LC is sealed between the glass substrates.

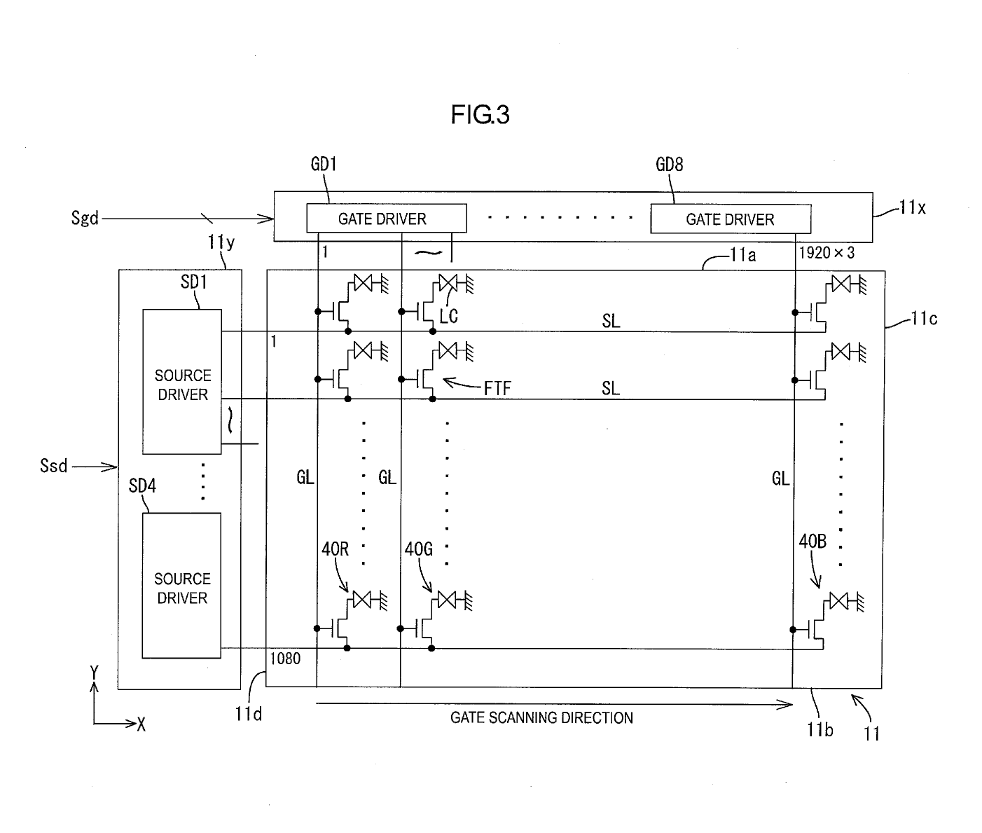

As illustrated in FIG. 3, on one of the glass substrates, switching components (for example, TFTs) connected to source lines (data lines) and gate lines (scan lines) which are perpendicular to each other, and an alignment film and the like are provided. A switching component TFT, the liquid crystal LC and the like form color unit pixels 40R, 40G and 40B such as R (red), G (green) and B (blue) and the color unit pixels 40R, 40G and 40B form a display pixel (hereinafter simply “pixel”) 40. The pixels 40 are arranged in a two-dimensional matrix in the liquid crystal panel 11.

In the first embodiment, as illustrated in FIG. 3, a plurality of gate lines GL are arranged so as to be scanned in the long-side direction (X-axis direction) of the liquid crystal panel 11 and a plurality of source lines SL are arranged so as to be scanned in the short-side direction (Y-axis direction) of the liquid crystal panel 11. The liquid crystal panel 11 is, for example, a high-definition liquid crystal panel. 1,920×3 (RGB) gate lines GL and 1,080 source lines SL are provided in the liquid crystal panel 11. The 1,920×1,080 pixels 40 are provided in the liquid crystal panel 11.

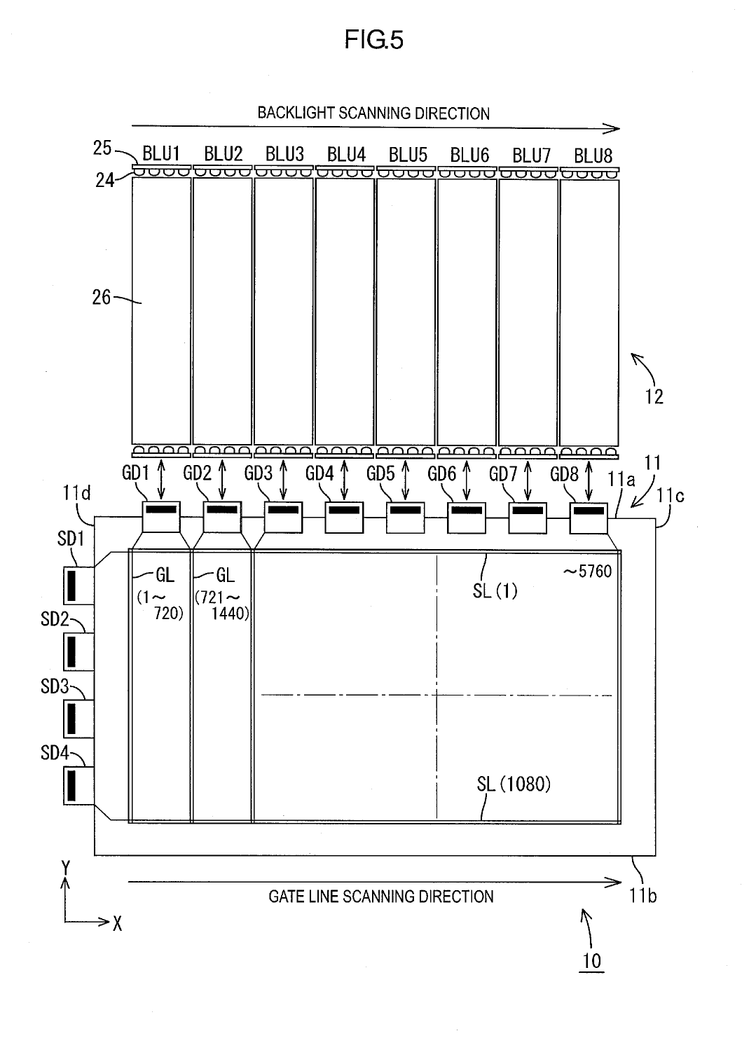

Gate drivers GD are arranged above the upper long side 11a of the glass substrate and connected to the gate lines GL. Source drivers SD are arranged next to the left short side 11d of the glass substrate and connected to the source lines SL. The gate drivers GD are configured to drive the gate lines GL. The source drivers SD are configured to drive the source lines SL. The gate drivers GD are connected to a gate driver board 11x. The source drivers SD are connected to a source driver board 11y. In the first embodiment, eight gate drivers (GD1 to GD8) and four source drivers (SD1 to SD4) are provided (see FIG. 5).

On the other substrate, color filters having color sections such as R (red), G (green) and B (blue) color sections arranged in a predetermined pattern, counter electrodes, and an alignment film and the like are provided in accordance with the arrangement of the unit pixels (40R, 40G and 40B). Polarizing plates are attached to outer surfaces of the substrates.

As illustrated in FIG. 2, the backlight device 12 includes a chassis 22, an optical sheet set 23 and a frame 27. The chassis 22 has a substantially box-shape and has an opening on the light exit side (on the liquid crystal panel 11 side). The optical sheet set 23 includes a diffuser (light diffusing member) 23a, and a plurality of optical sheets 23b which are provided between the diffuser 23a and the liquid crystal panel 11) and is provided so as to cover the opening of the chassis 22. The frame 27 provided along an outer edge of the chassis 22 holds an outer edge of the optical sheet set 23 such that the outer edge is sandwiched between the frame 27 and the chassis 22.

LEDs (light emitting diodes) 24 that are light sources, an LED board 25 on which the LEDs 24 are mounted, and a light guide member 26 are arranged in the chassis 22. The light guide member 26 is configured to direct light from the LEDs 24 in a short-side direction (Y-axis direction) of the liquid crystal panel 11, and to direct the light toward the optical member 23 (in the Z-axis direction).

A backlight unit BLU includes the LED board 25, the predetermined number (four by two in FIG. 2) of LEDs 24 and the light guide member 26. The backlight device 12 includes a plurality of backlight units BLU (eight in FIG. 2). An edge-light-type (side-light-type) backlight unit is used for the backlight device 12. The light guide member 26 is provided directly behind the liquid crystal panel 10 and the optical members 23, and the LED board 25 with the LEDs 24 is provided at the side edges of the light guide member 26.

2. Circuit Configuration

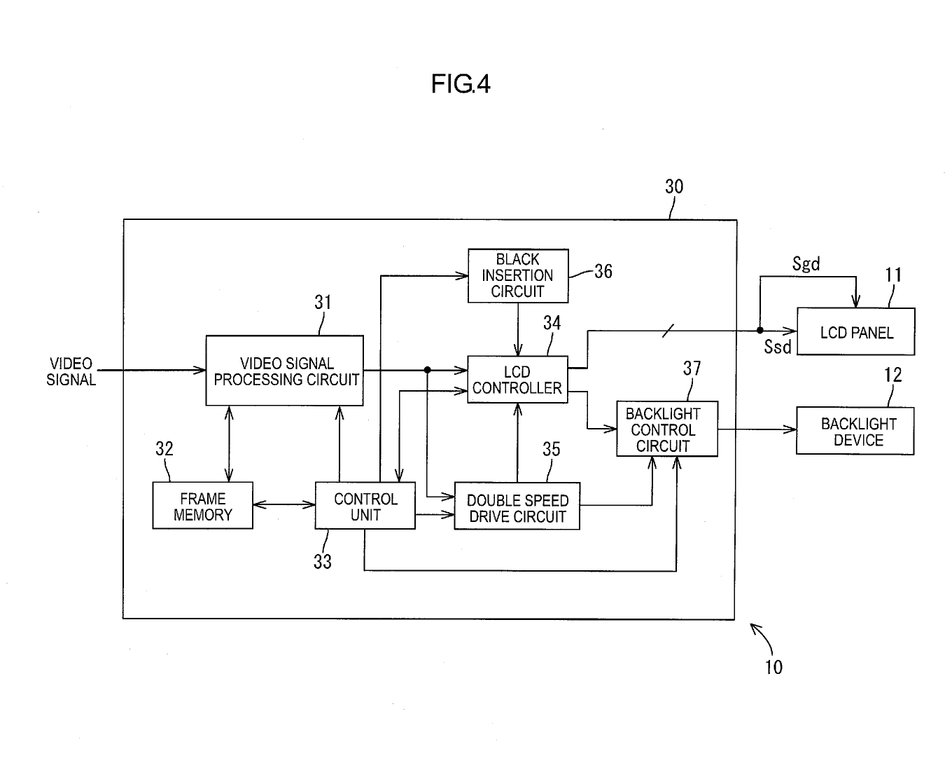

Next, the circuit configuration of the liquid crystal display device 10 will be described with reference to FIGS. 3 and 4. FIG. 3 schematically illustrates the arrangement of the pixels 40 in a matrix in the liquid crystal panel 11. FIG. 4 is a general block diagram of the circuit board 30 of the liquid crystal display device 10 according to the first embodiment.

The liquid crystal display device 10 of the first embodiment is connectable to an analog tuner, a digital tuner and a video processing device such as a digital camera and a recording device. The analog tuner receives analog video signals such as UHF television broadcast signals and VHF television broadcast signals. The digital tuner receives digital video signals such as digital terrestrial broadcast signals and broadcasting satellite digital broadcast signals. The liquid crystal display device 10 is configured to display images based on video signals received as input from the analog tuner, the digital tuner or the image processing device.

The liquid crystal display device 10 includes the circuit board 30. As illustrated in FIG. 4, the circuit board 30 includes a video signal processing circuit 31, a frame memory 32, a control unit 33, an LCD controller 34, a double speed drive circuit 35, a black insertion circuit 36, a backlight control circuit 37.

The control unit 33 includes a CPU (central processing unit) or an MPU (micro processor unit), for example. A ROM and a RAM are built in the CPU or the MPU. The control unit 33 is configured to control operations of hardware components as explained above. The control unit 33 reads out control programs that are stored in advance in the built-in ROM to the RAM as appropriate to run the control programs. Various control programs are stored in the ROM in advance. The RAM may be SRAM or SDRAM. The RAM temporarily stores data that is generated during execution of control programs by the control unit 33.

The video signal processing circuit 31 performs signal processing on the video signal received as input from the tuner T of the television receiver TV as necessary. The signal processing includes: YC separation processing that separates a signal into a luminance signal and a color signal; color conversion processing using a color matrix; IP conversion processing that converts an interlaced video signal to a progressive video signal; and A/D conversion processing that converts an analog signal to a digital signal. The control unit 33 and the video signal processing circuit 31 are connected to the frame memory 32. The control unit 33 is configured to store the video signal as appropriate in the frame memory 32 per frame. The video signal is subject to various signal processing by the video signal processing circuit 31.

In the first embodiment, the video signal processing circuit 31 is configured to store image data per frame into the frame memory 32. The video signal processing circuit 31 reads out the stored image data per frame for image data of an image at a position corresponding to each gate line that is scanned in the long-side direction (X-axis direction) of the liquid crystal panel 11. In the first embodiment, the scanning direction is changed at an angle of 90° compared to gate lines scanned in a short-side direction (Y-axis direction) of a display panel. Image data is read out from the frame memory 32 to the video signal processing circuit 31 along with the scanning.

The video signal processing circuit 31 performs various signal processing as described. The video signal processing circuit 31 reads out the video signal that is stored in the frame memory 32 per video frame. The video signal processing circuit 31 reads out each video frame at two times at a double frame rate to perform frame rate conversion processing. Namely, the video signal processing circuit 31 converts the received video signal having a frame rate of 30 Hz to a video signal having a frame rate of 60 Hz. Furthermore, a scaling circuit (not shown) performs scaling processing in accordance with the number of pixels of the liquid crystal panel 11 and outputs the video signal subject to scaling processing to the LCD controller 34.

The LCD controller 34 is connected to the liquid crystal panel 11 and the backlight control circuit 37. According to the control of the control unit 33, the LCD controller 34 drives the backlight control circuit 37, the gate drivers GD and the source drivers SD based on the video signal received as input from the video signal processing circuit 31. The LCD controller 34 displays video that is based on the video signal on the liquid crystal panel 11. The LCD controller 34A supplies a gate driver drive signal Sgd to the gate drivers GD. The gate driver drive signal Sgd includes a scanning signal for scanning the gate lines SL. The LCD controller 34A supplies a source driver drive signal Ssd to the source drivers SD. The source driver drive signal Ssd includes the pixel data.

The double speed drive circuit 35 is configured to change the frame rate of images to be displayed on the liquid crystal panel 11 in response to a request. The double speed drive circuit 35 performs, for example, frame interpolation processing on the video signal having a standard frame rate of 60 Hz that is converted in the video signal processing circuit 31. The double speed drive circuit 35 further converts the frame rate to 90 Hz, 120 Hz or 180 Hz, for example. The video signal having the converted frame rate is supplied to the LCD controller 34.

The frame rate is doubled to 120 Hz, for example. This reduces “motion blur (afterimage)” in display images (video) to improve video display performance. The double speed drive circuit 35 is configured to change the control frequency of the backlight device 12 in accordance with the frame rate. Accordingly, the double speed drive circuit 35 changes the drive frequency of the backlight control circuit 37 in accordance with the frame rate.

The black insertion circuit 36 inserts a black signal between the video signal frames in response to a request. This reduces afterimages.

In the first embodiment, the black insertion circuit 36 and the double speed drive circuit 35 insert a black signal into the video signals and change the frame rate. The insertion of a black signal and the change of the frame rate are optional. Namely, the double speed drive circuit 35 and the black insertion circuit 36 are optional and may not be necessary.

The backlight control circuit 37 drives the backlight device 12 according to a control signal from the LCD controller 34. In the first embodiment, the backlight control circuit 37 is configured to control turning on and off of each LED 24 in the backlight device 12 per backlight unit BLU. The backlight control circuit 37 scans and turns on the backlight units (BLU1 to BLU8) according to scanning operation of the gate drivers (GD1 to GD8).

The backlight control circuit 37 is configured to change amounts of currents that are supplied to a plurality of light sources in turning-on periods within a frame display period in accordance with turning-off periods (black signals insertion periods) of the LEDs 24 within the frame display period. Here, the backlight control circuit 37 is configured to increase the amounts of currents in proportion to the turning-off periods.

In the first embodiment, the amounts of currents supplied to the light sources vary in accordance with the turning-on periods (lighting duty) within a frame display period. Namely, brightness of the light sources in the turning-on periods is increased in proportion to the turning-off periods. Even if the liquid crystal panel 11 is large and the turning-on period becomes short (lighting duty is reduced), a desired amount of light sources is achieved.

3. Scan Lighting of Light Sources

Next, the scan lighting of a plurality of LEDs (light sources) 24 in the first embodiment will be described with reference to FIG. 5. FIG. 5 explains the correspondence relationships between the backlight device 12 and scanning of the gate drivers (GD1 to GD8). In FIG. 5, eight backlight units (BLU1 to BLU8) are provided for the backlight device 12 and eight gate drivers (GD1 to GD8) are provided for the liquid crystal panel 11. However, sixteen backlight units BLU may be provided for the backlight device 12 and sixteen gate drivers GD may be provided for the liquid crystal panel 11.

In the first embodiment, the backlight control circuit 37 scans and turns on a plurality of LEDs (light sources) 24 in the long-side direction (X-axis direction) of the liquid crystal panel 11 in accordance with driving operation of the gate drivers (GD1 to GD8) for scanning. Specifically, the backlight control circuit 37 performs the scan lighting of the LEDs 24 on backlight unit BLU basis. Namely, as illustrated in FIG. 5, the scan lighting of the LEDs 24 is performed on backlight unit basis (BLU1 to BLU8) according to each gate driver (GD1 to GD8) in the first embodiment.

Specifically, while the gate driver GD1 scans the gate lines GL1 to GL720 in a frame period, four LEDs 24 in the backlight unit BLU1 (the predetermined number of light sources) are turned on and the LEDs 24 in the backlight units (BLU2 to BLU8) are turned off. Next, while the gate driver GD2 scans the gate lines GL721 to GL1440, four LEDs 24 of the backlight unit BLU2 are turned on and the LEDs 24 in the backlight units (BLU1 and BLU3 to BLU8) are turned off.

In the first embodiment, a plurality of LEDs 24 are arranged in the long-side direction (X-axis direction) of the liquid crystal panel 11 in the edge-light-type backlight device 12. The LEDs 24 are turned on through the scan lighting in the long-side direction (X-axis direction) of the liquid crystal panel 11. Conventionally, the scanning direction of a liquid crystal panel is the short-side direction (Y-axis direction) thereof. A plurality of light sources are arranged in the short-side direction (Y-axis direction) of the display panel, and a plurality of light sources are turned on through scan lighting in the short-side direction (Y-axis direction) of the display panel. Compared to such a configuration, the length of the long side of the light guide member 26 is shorter, and the number of light sources that are turned on through the scan lighting is increased. Accordingly, the edge-light-type backlight device 12 configured to perform the scan lighting can be applied in a large-screen display liquid crystal display device. With the backlight sources driven through the scan lighting, the large-screen liquid crystal display device and the television receiver can display images in improved quality.

### Second Embodiment

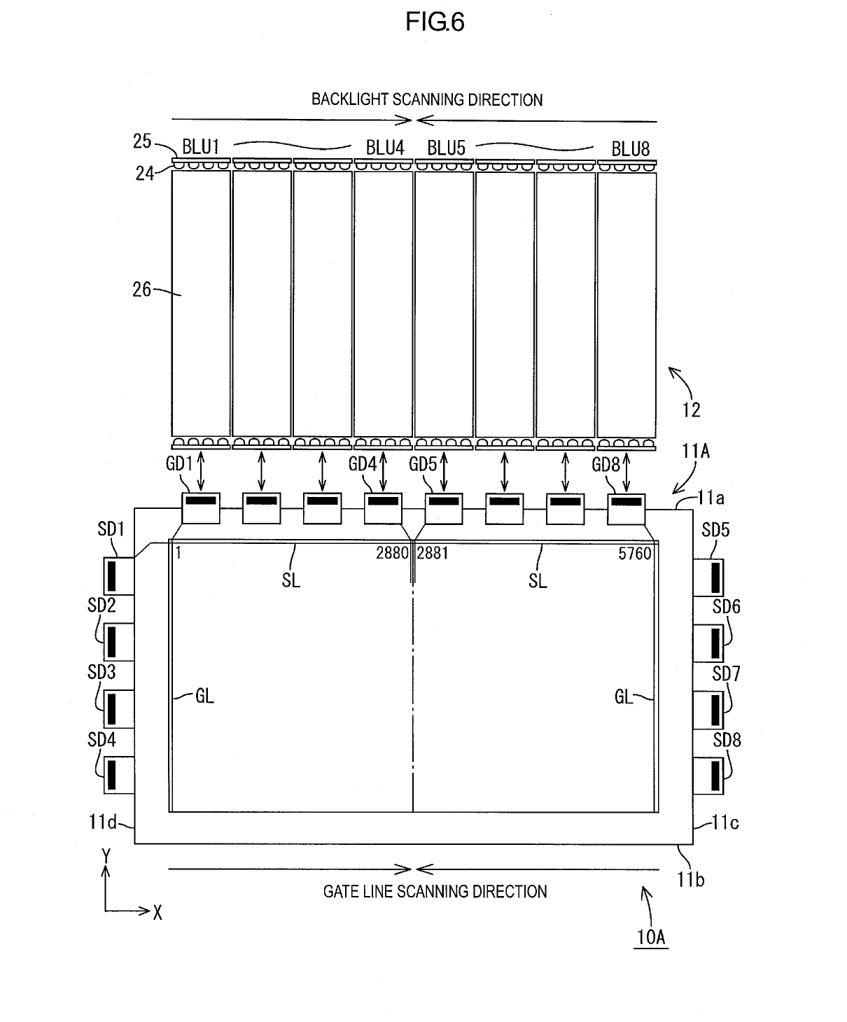

Next, a second embodiment of the present invention will be explained with reference to FIG. 6. FIG. 6 illustrates correspondence relationships between the backlight device 12 and scanning of the gate drivers (GD1 to GD8) in the liquid crystal display device 10A according to the second embodiment. The construction of the liquid crystal panel 11A is partially different from the first embodiment. The construction, operations and effects as same as the first embodiment will not be explained.

The image display of the liquid crystal panel is not divided in the first embodiment. However, the technology according to the present invention can be applied to an image display that is divided into sections. In the second embodiment, an image display is divided into sections. As illustrated in FIG. 6, the image display in the second embodiment is divided into two sections.

The source lines SL are provided right and left so as to be separated in the middle of the display (illustrated in a dashed-dotted line) as illustrated in FIG. 6. The source drivers (SD5 to SD8) are provided next to the right short side 11c of the liquid crystal panel 11A.

The gate lines GL are scanned preferably from the right side and the left side of the liquid crystal panel 11 toward the middle, respectively, as indicated by arrows in FIG. 6. Specifically, the gate lines GL are scanned from the gate line GL1 to the gate line GL2880 and from the gate line GL5760 to GL2881. The scan lighting of the LEDs 24 are preferably performed from the right side and the left side of the liquid crystal panel 11 toward the middle, respectively, in accordance with the time periods in which the gate drivers (GD1 to GD8) are selected. The scanning in such directions is preferable to reduce the deterioration of display quality near the division borders due to the division of display, and thus the division borders are less likely to be recognized.

In two-split-screen display, the double speed drive circuit 35 performs the double speed driving, namely, images are displayed at a frame rate of 120 Hz. This enhances the effect of reducing a flicker and a “motion blur,” and can reduce a thickness of a large-screen liquid crystal display device. Even the image display is divided into four sections: right, left, top and bottom, to support a high-definition large-screen liquid crystal display device, such a configuration according to the present invention is applicable to such a display device. A plurality of gate lines GL are provided so as to be separated in the short-side direction Y of the liquid crystal panel 11 and a plurality of gate drivers GD are arranged on both long-sides of the liquid crystal display device 11. Therefore, the technology according to the present invention is applicable in liquid crystal display devices that use a multiple-split-screen display system regardless of the number of sections.

The scanning directions of the gate lines GL and the LEDs 24 in two sections, right and left in the liquid crystal panel 11 as illustrated in FIG. 6, may be altered. For example, the scanning may be performed from the middle to the left and the right side, respectively, from each left side to each right side, or from each right side to each left side.

### Other Embodiments

The present invention is not limited to the above embodiments described in the above description and the drawings. The following embodiments are also included in the technical scope of the present invention, for example.

(1) In the above embodiments, the LEDs (light sources) 25 are turned on through the scan lighting in the long-side direction (X-axis direction) of liquid crystal panel 11 on backlight unit basis (BLU1 to BLU8) according to each gate driver (GD1 to GD8).

However, for example, the LEDs 24 are not necessarily turned on through the scan lighting according to each gate driver (GD1 to GD8). The LEDs 24 may be turned on through the scan lighting according to the predetermined number of gate lines.

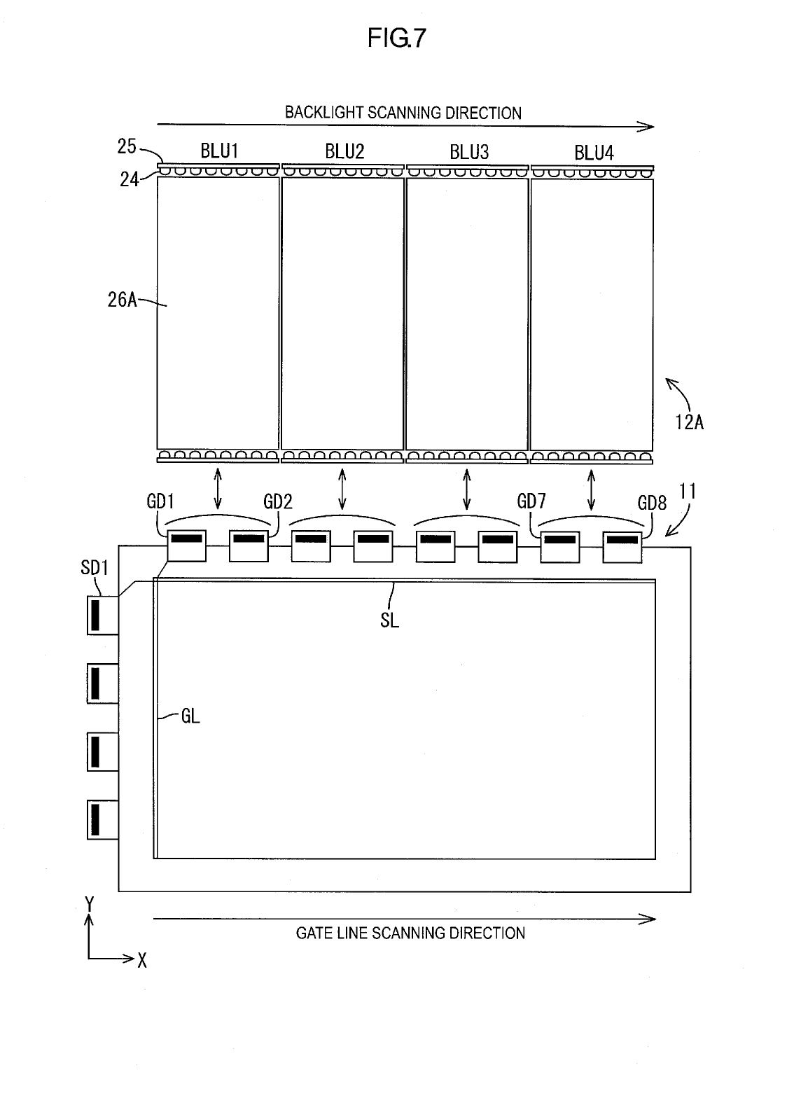

As illustrated in FIG. 7, the backlight device 12A may include four backlight units (BLU1 to BLU4). Each backlight unit (BLU1 to BLU4) may be provided so as to be associated with two gate drivers. The LEDs (light sources) 25 may be turned on through scan lighting on backlight unit basis (BLU1 to BLU4) according to the two gate drivers GD. Moreover, the single gate driver GD may be associated with two backlight units BLU. Therefore, the number of gate drivers GD associated with the backlight units BLU is not limited to a specific number.

Furthermore, the LEDs 24 in the backlight unit BLU may be divided into groups, each of which includes the predetermined number of LEDs 24. The LEDs 24 may be turned on through the scan lighting per group according to the gate drivers GD.

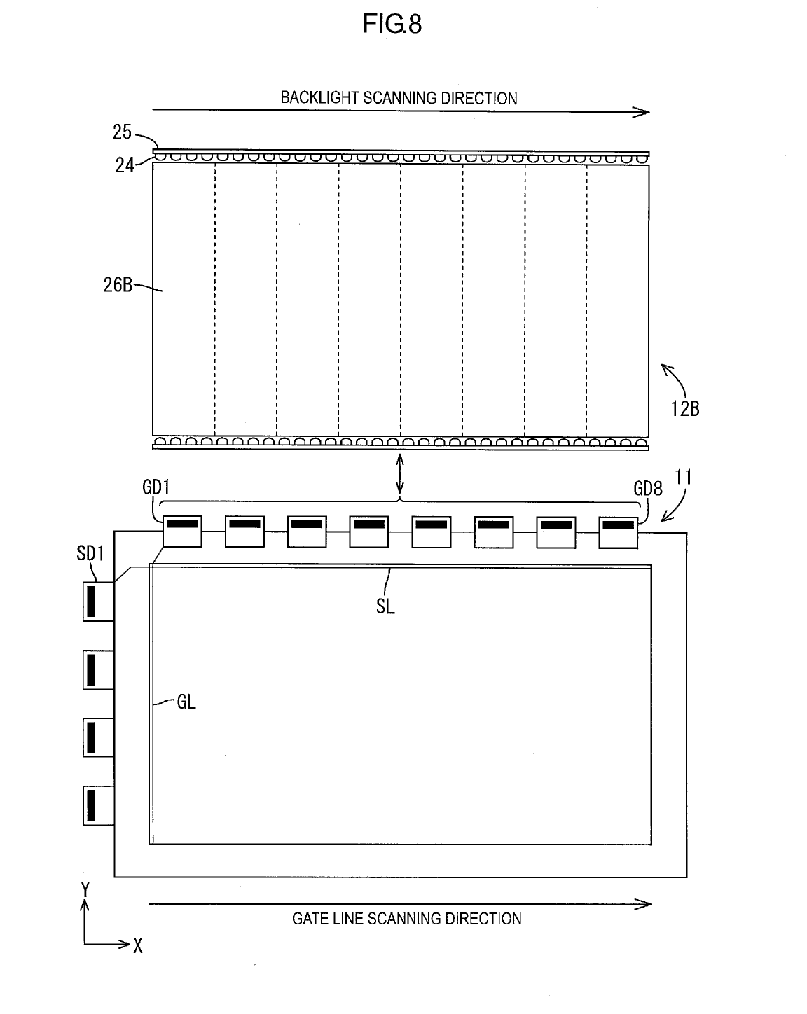

As illustrated in FIG. 8, the backlight device 12B may include a single light guide member 26B and a plurality of LEDs 24 instead of the backlight units. In this case, the light guide routes of the light guide member 26B are defined for each of the predetermined number of LEDs 24, for example, each of the four LEDs 24, as indicated by a dotted line in FIG. 8.

In the example, each of the four LEDs 24 may be turned on through the scan lighting during the time periods in which the gate drivers (GD1 to GD8) are selected similar to the embodiments. Furthermore, the predetermined number of LEDs 24 may be turned on through the scan lighting corresponding to every predetermined number of gate lines. Or, the individual LEDs 24 may be turned on through the scan lighting corresponding to every predetermined number of gate lines.

(2) In the above embodiments and other embodiments, the LED boards 25 and the LEDs 24 are arranged on the long side ends of the light guide members 26. However, the LED boards 25 and the LEDs 24 may be arranged only one of the long side ends of the light guide members 26 in accordance with a size of the liquid crystal panel 11.

(3) In the above embodiments and other embodiments, a plurality of light sources are a plurality of LEDs 24. However, a plurality of light sources may be a plurality of cold cathode tubes, for example.

(4) In the above embodiments and other embodiments, the light sources (the LEDs 24) are turned on through the scan lighting in a unit of the predetermined number of light sources. However, the scan lighting of a plurality of light sources may be performed per light source unit.

(5) In the above embodiments and other embodiments, the unit pixels (40R, 40G and 40B) are arranged in the long-side (X-axis) direction of the liquid crystal panel 11 as illustrated in FIG. 3. However, the unit pixels (40R, 40G and 40B) may be arranged in the short-side (Y-axis) direction of the liquid crystal panel 11. Namely, the technology according to the present invention is applicable to a liquid crystal panel that is configured with the 1,920 gate lines GL arranged in the long-side (X-axis) direction and the 1,080×3 (RGBs) source lines SL arranged in the short-side (Y-axis) direction.

### EXPLANATION OF SYMBOLS

10: liquid crystal display device, 11: liquid crystal panel, 12: backlight device, 31: video signal processing circuit, 32: frame memory, 34: LCD controller, 35: double speed drive circuit, 37: backlight control circuit, BLU1-BLU8: backlight unit, GD1-GD8: gate driver, GL: gate line, LED: light emitting diode, SD1-SD4: source driver, SL: source line, TV: television receiver

1. A display device comprising:
a display panel formed in a rectangular shape having two long sides and two short sides and including a plurality of display pixels arranged in rows and columns, the display panel including
a plurality of data lines arranged in a long side direction of the display panel and configured to supply display data to the display pixels, and
a plurality of scan lines arranged in a short side direction of the display panel and configured to be driven and scanned in the long side direction of the display panel; and
a backlight device configured to illuminate the display panel, the backlight device including
a plurality of light sources provided in a vicinity of an edge of one of the long sides of the display panel and arranged in the long side direction thereof, the light sources being configured to be turned on through scan lighting in the long side direction of the display panel according to scanning of the scan lines, and
a light guide member provided behind the display panel and configured to direct light from the light sources in the short side direction of the display panel.

2. The display device according to claim 1, wherein the light sources are turned on through the scan lighting per light source unit including a predetermined number of light sources.

3. The display device according to claim 2, wherein:
the backlight device includes a plurality of light source units each including at least one of the light sources and the light guide member; and
the light sources are configured to be turned on through scan lighting on the light source unit basis.

4. The display device according to claim 2, wherein:
the backlight device includes a plurality of light source units each including the predetermined number of light sources and the light guide member;
the predetermined number of the light sources is provided in a plurality of groups; and
the light sources are configured to be turned on through the scan lighting on the group basis.

5. The display device according to any one of claim 1, further comprising a plurality of scanning line drivers provided close to one of the long sides of the display panel and configured to drive and scan the scan lines, wherein the light sources are turned on through the scan lighting on the scanning line driver basis.

6. The display device according to claim 1, wherein:
the data lines are provided in two groups in a middle portion of the display panel; and
the scan lines are provided in the groups and configured to be scanned separately.

7. The display device according to claim 6, wherein the scan lines are configured to be scanned from short side edges of the display panel to the middle portion thereof.

8. The display device according to claim 6, wherein:
the scan lines are provided in groups in the short side direction of the display panel; and
the scanning line drivers are provided close to the long sides of the display panel.

9. The display device according to claim 1, further comprising:
a frame memory configured to store image data per frame included in a video signal; and
a video signal processing circuit configured to store the image data per frame into the frame memory and read out the stored image data per frame for image data of an image at a position corresponding to the each scan line.

10. The display device according to claim 1, further comprising a double speed drive circuit configured to change a frame rate of images to be displayed on the display panel.

11. The display device according to claim 1, further comprising a backlight control circuit configured to change an amount of current supplied to the light sources in turning-on periods within a frame display period in accordance with turning-off periods within the frame display period.

12. The display device according to claim 11, wherein the backlight control circuit is configured to increase the amount of current in proportion to the turning-off periods.

13. The display device according to claim 1, wherein the light sources are light emitting diodes.

14. The display device according to claim 1, wherein the display panel is a liquid crystal panel using liquid crystals filled between base boards.

15. A television receiver comprising the display device according to claim 1.
